(19) United States
(12) Patent Application Publication
(10) Pub. No.: US 2005/0012824 A1
(43) Pub. Date: Jan. 20, 2005

(54) Camera remote control with framing controls and display

(76) Inventors: Donald J. Stavely, Windsor, CO (US); Andrew C. Goris, Loveland, CO (US); Linda A. Kennedy, Fort Collins, CO (US); Victoria L. Naffier, Fort Collins, CO (US); Robert F. Yockey, Fort Collins, CO (US); Lisa K. Roberts, Fort Collins, CO (US); George Prokop, Loveland, CO (US); James S. Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/623,214

(22) Filed: Jul. 18, 2003

(51) Int. Cl. H04N 5/232

(52) U.S. Cl. 348/211.99

(57) ABSTRACT

A photography system includes a digital camera and a remote control that wirelessly communicates with the camera. The remote control includes controls for causing the camera to select a region from its field of view to photograph. The selected region may include the entire field of view of the camera or a portion thereof. The remote control also includes a display screen that shows the photographer the selected region, thus providing feedback that the photographer can use to adjust the selection. The camera may optionally be a still camera, a video camera, or may be capable of taking both still photographs and video recordings.

### FIELD OF THE INVENTION

The present invention relates generally to photography.

### BACKGROUND OF THE INVENTION

A common inconvenience in consumer photography is that the photographer cannot easily be included in the scene being photographed. Some cameras provide a “self-timer” that allows the photographer to compose a photograph, activate the timer, and place herself in the scene in time to be included in a photograph taken by the camera upon expiration of the timer. However, this solution requires considerable preparation and lacks spontaneity.

Other cameras include a remote control device that can activate the camera from a distance. The photographer can position the camera, place herself in the scene, and use the remote control to take photographs whenever she desires. However, this method gives the photographer no feedback about or control over the composition of the photograph, and does not adapt well to changing scenes.

The inconvenience is particularly acute in video photography. The videographer must typically choose between letting the camera run unattended during an activity, resulting in an unartful recording, or must remove himself from the activity for the duration of the recording to tend to the camera.

Other photographic situations may be envisioned wherein the photographer or videographer wishes to compose and take photographs or video recordings of a scene without the need to tend to the camera continually, whether or not the photographer or videographer wishes to be included in the resulting photograph or recording. What is needed is a system and method for conveniently and artfully photographing or video recording a scene, which scene may include the photographer, while the camera operator is separated from the camera.

### SUMMARY OF THE INVENTION

A photography system includes a digital camera and a remote control that wirelessly communicates with the camera. The remote control includes controls for causing the camera to select a region from its field of view to photograph. The selected region may include the entire field of view of the camera or a portion thereof. The remote control also includes a display screen that shows the photographer the selected region, thus providing feedback that the photographer can use to adjust the selection. The camera may optionally be a still camera, a video camera, or may be capable of taking both still photographs and video recordings.

### BRIEF DESCRIPTION OF THE DRAWINGS

FIG. 1 depicts a system in accordance with an example embodiment of the invention.

FIG. 2 depicts a camera situated so that its field of view encompasses a relatively large area of interest.

FIG. 3 shows a close up view of a remote control.

FIG. 4 represents an array of pixels.

FIG. 5 depicts a particular region being selected from the camera's field of view.

FIG. 6 shows how the display of the remote control of FIG. 3 may appear when a particular region has been selected from the camera's field of view.

### DETAILED DESCRIPTION OF THE PREFERRED EMBODIMENT

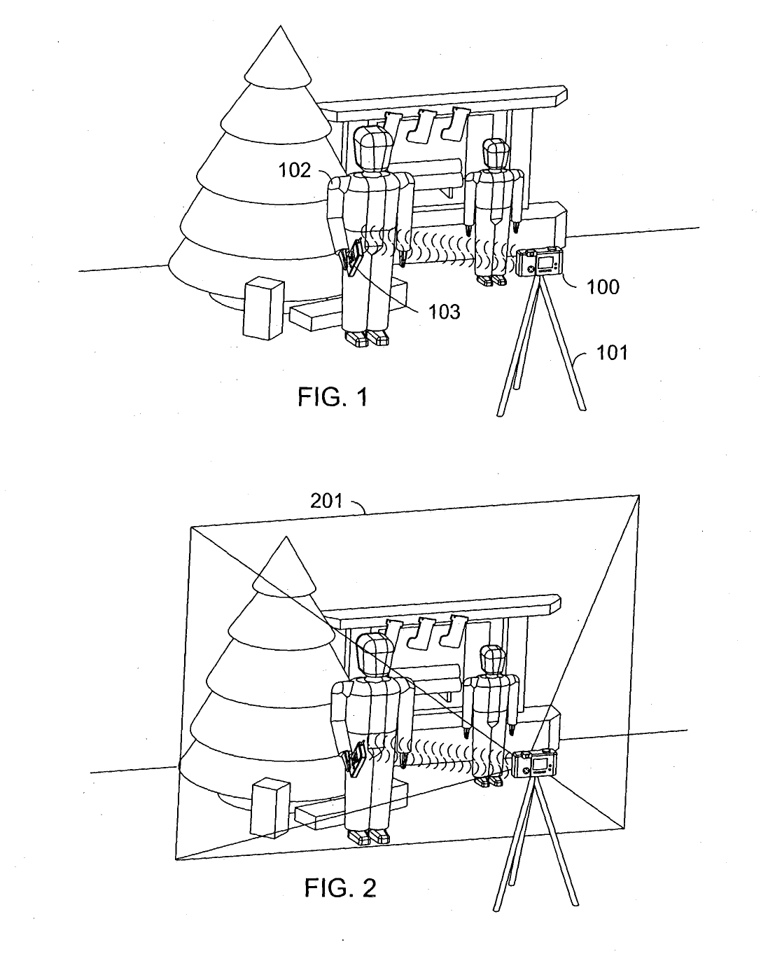

FIG. 1 depicts a system in accordance with an example embodiment of the invention, and placed in an example photographic situation where the system can be used to good advantage.

Camera 100 may be placed on a tripod 101 or otherwise held substantially stationary. Camera 100 is directed at a scene to be photographed. Photographer 102 holds a remote control 103, which communicates wirelessly with camera 100.

Camera 100 may have a zoom lens or a lens with a fixed focal length. If camera 100 has a zoom lens, it may be configured to a relatively short focal length so as to give the camera a relatively wide field of view. A relatively short focal length is one that is near the shortest focal length the camera is capable of. For example, in a camera with a focal length range of 6 to 18 mm, a focal length near 6 mm would be relatively short. As shown in FIG. 2, camera 100 is situated so that the field of view 201 of the lens encompasses a relatively large area of interest, from which regions may be selected to photograph.

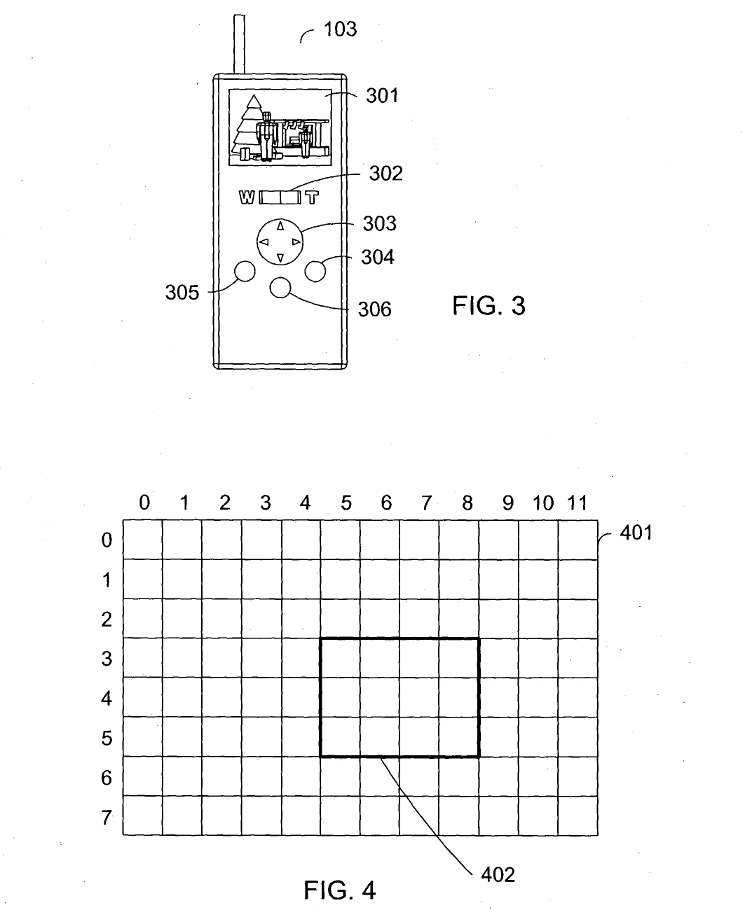

FIG. 3 shows a close up view of remote control 103. Remote control 103 comprises a display 301, which displays visual information transmitted to remote control 103 by camera 100. Display 103 may be a liquid crystal display, a plasma display, or another kind of display capable of showing visual information. The information shown on display 301 is a representation of the scene viewed by camera 100 or a portion thereof. Display 301 may be thought of as a remote preview screen. A digital camera such as camera 100 typically provides a display screen integrated into the camera body for communicating information about the operation of the camera, for displaying of photographs taken by the camera, and for showing a preview of photographs to be taken for assisting the user of the camera in composing photographs. The preview typically consists of sequential digital images taken by the camera and shown in relatively rapid succession. Images shown in sufficiently rapid succession may be considered to be a video sequence. The preview images may be at a lower resolution than the camera is capable of. A camera preview mode as described is well known in the art.

Camera 100 may transmit its preview information to remote control 103, which shows the information on display 301. The transmission may be accomplished with a wireless communication interface such as one using the Bluetooth standard or the IEEE 802.11 standard. Each of these communication interfaces uses radio communication operating in a frequency band between 2.4 and 2.4835 gigahertz, often referred to as simply 2.4 gigahertz, and has sufficient bandwidth and power to transmit and receive compressed video across distances of several meters. Chipsets for implementing either of these interfaces are readily available. Other interfaces may also be used within the scope of the appended claims.

Remote control 103 also comprises various controls operated by the photographer 102. The controls allow photographer 102 to perform digital framing of photographs to be taken by camera 100. Digital framing is the selection and sizing of a region from the field of view of camera 100.

A digital camera such as camera 100 typically uses a lens to project an image of a scene onto an electronic array light sensor. The electronic array light sensor typically comprises many light-sensitive elements sometimes called “pixels”. Each pixel measures the brightness of light emanating from a corresponding location in the scene. The electronic array light sensor typically accumulates electrical charge in each pixel in proportion to the brightness of light falling on the pixel. This charge quantity is then measured to determine a numerical value. The numerical value is also often called a “pixel”. The meaning of the term “pixel” is generally clear from the context of the reference. The set of numerical values resulting from the measurement of the charges from the pixels of the electronic array light sensor may be collected into a numerical array. The numerical array may be called a digital image, a digital photograph, or sometimes simply an image or a photograph. When properly interpreted and displayed, the digital image reproduces the scene photographed by the camera.

In some cases, fewer than all of the pixels on the electronic array light sensor need be measured to determine numerical values. For example, if a photograph of lower resolution than the camera is capable of is desired, or if a photograph of only a portion of the camera's field of view is desired, some accumulations of electrical charge may be discarded without being measured.

FIG. 4 represents an array of pixels 401, and may be thought of as representing the light-sensitive pixels on an electronic array light sensor or as representing corresponding elements in a digital image array. Only a few pixels are shown in FIG. 4 for simplicity of explanation. An actual camera may have many thousands or millions of pixels. Many digital cameras use selective wavelength filtering on some pixels to record color information about a scene, allowing such cameras to produce color photographs. One of skill in the art will recognize that the present invention may be embodied in a camera with color capability or one without.

In FIG. 4, the entire array 401 corresponds to the entire camera field of view 201, and in fact the size of the electronic array light sensor and the characteristics of the lens of camera 100 define the camera's field of view 201. A subarray 402 of pixels may be selected from array 401 in order to select a particular region from the field of view 201 of camera 100. In FIG. 4, subarray 402 has its origin at row 3, column 5 of array 401, and subarray 402 is four pixels wide and three pixels high.

The size and location of subarray 402 may be specified and controlled by the photographer 102 using remote control 103. In an example embodiment, remote control 103 may comprise a four-way rocker switch that allows the photographer 102 to simulated “pan” and “tilt” motions of the camera. For example, the photographer 102 may press the right-pointing arrow of four-way rocker switch 303. In response, remote control 103 may send a signal to camera 100 indicating that the logic of camera 100 should “move” subarray 402 (or, more accurately, select a different subarray) so that it corresponds to a farther-right region of the camera's field of view 201. Camera 100 may select the new subarray, and use only that portion of field of view 102 as the preview image transmitted to remote control 103 and displayed on remote control 103. In this way, the photographer can select a preferred portion of the scene to photograph—that portion encompassed by the selected region of field of view 102. As subarray 402 “moves” across the array 401, the preview image on screen 301 of remote control 103 appears to pan across the scene, even though the camera remains stationary. This simulation of a panning motion of the camera may be called a “digital pan”.

Similarly, the photographer 102 may execute a “digital tilt” by pressing the upward or downward pointing arrows on four-way rocker switch 303. In reaction, the camera logic may select a different subarray 402, and transmit the resulting preview image to remote control 103. The preview image shown on display 301 appears to move as if the camera were being tilted up or down.

A “digital zoom” may also be provided. For example, the photographer may press one side of rocker switch 302. In response, remote control 103 sends a signal to camera 100 indicating that a larger or smaller subarray 402 is to be selected. In response, the camera logic may select more or fewer pixels to be used to provide a preview image. For example, if the photographer 102 presses the “T” (for “telephoto”) side of switch 302, the camera may reduce the size of subarray 402 without moving the center of subarray 402 in relation to the entire array 401. The resulting digital image derived from the subarray may then resized appropriately for showing on display 301, and transmitted to remote control 103. The resulting display on remote control 103 makes it appear as if the camera's lens focal length were changed.

This functions of digital pan, digital tilt, and digital zoom, performed individually or in any combination, may be referred to as digital framing. Other kinds of controls may be used to implement these functions. For example, digital panning and tilting may be controlled by separate rocker switches on remote control 103 rather than by a four-way rocker switch. Simple individual buttons may be used for each control direction. One of skill in the art will recognize that many other control layouts may be used within the scope of the appended claims.

In an alternative example embodiment, camera 100 may send to the remote control a preview image that includes the entire field of view 201, and the remote control itself may perform the digital framing. In this alternative example embodiment, the controls on the remote control 103 cause the remote control 103 to simply display a selected portion of the camera's field of view 201. When the photographer 102 is satisfied with the composition and indicates, using a control on remote control 103, that a photograph should be taken, remote control 103 sends a signal to camera 100 indicating both that a photograph should be taken and what portion of field of view 201 should be included.

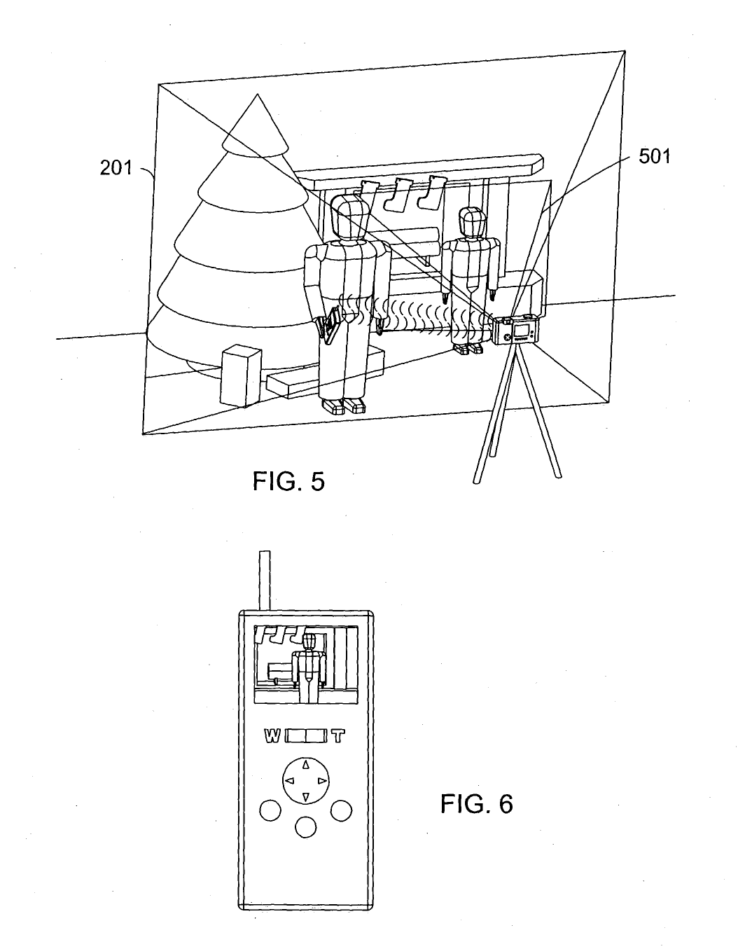

The display 301 of remote control 103 as depicted in FIG. 3 shows how the display may look when the entire field of view 102, corresponding to the entire array 401, is selected for photographing. FIG. 5 depicts a particular region 501, possibly corresponding to subarray 402, being selected from the camera's field of view 201. FIG. 6 shows how the display 301 of remote control 103 may appear when region 501 has been selected by appropriate digital framing.

Once the desired digital framing has been accomplished, the photographer 102 may cause a final photograph to be taken by pressing another control on remote control 103. For example, button 304 may cause a signal to be transmitted to camera 100, instructing camera 100 to take a photograph including only the selected region of the camera's field of view. Camera 100 may scale the resulting digital image to a larger or smaller size, for example to make it appear as if it were taken with the camera's full resolution, or to conserve image storage capacity.

The system may be similarly used for video recording. The photographer 102 may select a region to be recorded using digital framing, and then may activate recording by using a control on remote control 103. For example, button 305 may be cause camera 100 to start recording video, and button 306 may cause it to stop. Further digital framing may occur during video recording, allowing for substantial creativity and control on the part of the photographer 102.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A photography system, comprising:
a) a digital camera; and
b) a remote control that communicates wirelessly with the digital camera, the remote control having a display and having controls that cause the system to perform digital framing that selects a region from a field of view of the camera, and wherein the display displays an image of a scene encompassed by the selected region.

2. The photography system of claim 1 wherein the selected region includes the entire field of view of the camera.

3. The photography system of claim 1 wherein the selected region includes a portion of the field of view of the camera.

4. The photography system of claim 1 wherein digital framing includes a digital pan function.

5. The photography system of claim 1 wherein digital framing includes digital tilt function.

6. The photography system of claim 1 wherein digital framing includes a digital zoom function.

7. The photography system of claim 1 wherein the image of the scene encompassed by the selected region is displayed repetitively.

8. The photography system of claim 1 wherein the camera can record still images.

9. The photography system of claim 1 wherein the camera can take video recordings.

10. The photography system of claim 1 wherein the camera can record still images and can take video recordings.

11. The photography system of claim 1 wherein the remote control communicates wirelessly with the camera using radio signals.

12. The photography system of claim 11 wherein the radio signals have frequencies between 2.4 and 2.4835 gigahertz.

13. The photography system of claim 1 wherein the digital camera comprises a zoom lens, and wherein the zoom lens is configured to a relatively short focal length.

14. The photography system of claim 1 wherein the remote control further comprises a control that causes the camera to take a photograph.

15. The photography system of claim 14 wherein the photograph is of the scene encompassed by the selected region.

16. The photography system of claim 1 wherein the remote control further comprises controls that cause the digital camera to start and stop the making of a video recording.

17. The photography system of claim 16 wherein the video recording is of the scene encompassed by the selected region.

18. The photography system of claim 16 wherein digital framing can be performed during the making of a video recording.

19. The photography system of claim 1 wherein the digital framing is performed in the digital camera.

20. The photography system of claim 1 wherein the digital framing is performed in the remote control.

21. A method of photography, comprising the steps of:
a) transmitting a first wireless signal from a remote control to a digital camera;
b) performing digital framing in the digital camera in response to the wireless signal, selecting a region from a field of view of the digital camera;
c) transmitting a second wireless signal from the digital camera to the remote control, the second wireless signal containing information about a scene encompassed by the selected region; and
d) displaying, on a display on the remote control, a representation of the scene encompassed by the selected region.

22. The method of claim 21 wherein performing digital framing comprises performing a digital pan function.

23. The method of claim 21 wherein performing digital framing comprises performing a digital tilt function.

24. The method of claim 21 wherein performing digital framing comprises performing a digital zoom function.

25. The method of claim 21 wherein the first and second wireless signals are transmitted using radio signals.

26. The method of claim 21, further comprising the steps of:
a) transmitting a third wireless signal from the remote control to the digital camera; and
b) taking a photograph in response to the third wireless signal.

27. The method of claim 26 wherein the photograph is of the scene encompassed by the selected region.

28. The method of claim 21, further comprising the steps of:
a) transmitting a third wireless signal from the remote control to the digital camera; and
b) making a video recording in response to the third wireless signal.

29. The method of claim 28 wherein the video recording is of the scene encompassed by the selected region.

30. The method of claim 21 wherein the selected region includes the entire field of view of the digital camera.

31. The method of claim 21 wherein the selected region includes a portion of the field of view of the digital camera.

32. The method of claim 21 further comprising the step of configuring a zoom lens of the digital camera to a relatively short focal length.

33. A photography system, comprising:
a) means for wirelessly communicating between a remote control and a digital camera;
b) means for performing digital framing in the digital camera in response to the wireless signals from the remote control; and
c) means for displaying on the remote control a representation of a scene encompassed by a selected portion of a field of view of the camera.

34. A method of photography, comprising the steps of:
a) transmitting a first wireless signal from a digital camera to a remote control, the first wireless signal containing information about a scene encompassed by a field of view of the digital camera;
b) performing digital framing in the remote control in response to controls on the remote control;
c) displaying, on a display on the remote control, a selected region of the field of view that results from the digital framing; and
d) transmitting a second wireless signal from the remote control to the digital camera, the second wireless signal indicating that a photograph is to be taken and the location in the field of view of the selected portion.
